(19) United States
(12) Patent Application Publication
(10) Pub. No.: US 2011/0165343 A1
(43) Pub. Date: Jul. 7, 2011

(54) FRESNEL LENS COATING PROCESS

(75) Inventors: Peiqi JIANG, Tarpon Springs, FL (US); Lois WARREN, St. Petersburg, FL (US); Danne WRIGHT, St. Petersburg, FL (US)

(73) Assignee: ESSILOR INTERNATIONAL (COMPAGNIE GENERALE D'OPTIQUE), Charenton-Le-Pont (FR)

(21) Appl. No.: 12/651,646

(22) Filed: Jan. 4, 2010

(51) Int. Cl. B05D 3/06

(52) U.S. Cl. 427/553

(57) ABSTRACT

The present method for coating a Fresnel lens comprises providing an uncoated Fresnel lens blank having a structure surface and a non-structured surface, providing a transparent mold part having molding surface substantially matching the base curvature of the Fresnel lens, depositing a metered quantity of coating resin between the molding surface and the structured surface of the Fresnel lens, applying pressure between the Fresnel lens and the mold part while maintaining the distance between the molding surface and the structure surface so that the thickness of the coating is greater than 1.5 times the Fresnel structural height of the structured surface and less than 5 times of the Fresnel structure height of the structured surface and curing the resin coating in situ by directing the incident UV radiation at the Fresnel lens.

### FIELD OF THE INVENTION

The present application relates to a process for coating Fresnel lenses, and in particular for coating Fresnel lenses for ophthalmic lens applications.

### BACKGROUND OF THE INVENTION

There is an increasing interest in adopting Fresnel lenses which are diffractive lenses for certain ophthalmic applications in lieu of more conventional refractive lenses. Among the reasons for the increased interest in Fresnel lenses for ophthalmic applications are to increase lens optical power or reduce lens thickness.

One problem which has slowed the industrial development of Fresnel lenses for ophthalmic applications is related to their fabrication. A Fresnel lens conventionally has a so-called structured side or surface including a plurality of concentric ridges of different thickness and dihedral angles which collectively focus the lens. Fresnel lens like refractive lenses may have a variety of powers. The structured surface of the Fresnel lens can be provided on a planar, convex or concave side thereof.

While it is possible to use an uncoated Fresnel lens as an ophthalmic lens, an uncoated structured side is the source of a host of problems, relating to the structured side or surface of the lens which is both unsightly when worn and impractical from the standpoint of user care of the lens. To avoid such drawbacks it has been generally agreed that the structured side or surface of the Fresnel lens needs to be coated for reasons of aesthetics and ophthalmic lens care.

The coating of the structured side or surface of a Fresnel lens poses a significant problem in the fabrication of Fresnel lenses for ophthalmic applications. Conventional coating processes widely employed for coating ophthalmic lenses such as spin coating, dip coating or flow coating are inapplicable for coating the structured side or surface of a Fresnel lens because the classic coating processes cannot be adapted to produce acceptably smooth coated structured surfaces substantially devoid of waviness.

Various techniques are known for use in making Fresnel lenses which include a layer overlying the structured surface of the Fresnel lens. These techniques include overmolding, casting and BST (back side treatment). Fresnel lens structures with a layer covering the structured surface are disclosed in EP 1 830 204, US2008/00947 and US2004/0263982. None of these disclose a fully satisfactory process for producing coated Fresnel lenses devoid of optical and cosmetic defects, especially when the Fresnel structure height of the lens is in excess of 30 μm.

The inventors have discovered that it is possible to achieve good quality coating of the structured side or surface of a Fresnel lens from the optical and ‘cosmetic’ standpoints with a so-called press coating process such as disclosed in the assignee's published application EP 1 701 838 and counterpart U.S. published patent applications US2005140033 and US US2007516870, the content of which is incorporated by reference.

The foresaid patent applications teach the coating of fined (or fine ground) lens blanks to avoid having to polish the lens blank which is a lengthy and costly step in the fabrication of ophthalmic lenses. The unpolished lens blank typically has a roughness Rq from 0.01 to 1.5 μm and most commonly about 0.5 μm. A cured coating 1 to 50 μm thick and more commonly less than 5 μm is applied to the unpolished fined lens surface in accordance press coating process disclosed therein.

In the press coating process a requisite amount of a liquid, curable coating composition is deposited on a molding surface of a coating mold part or the unpolished fined surface of the lens blank to be coated. The mold part has a matching curvature to that of the unpolished fined surface of the lens blank. In practice the lens blank is mounted on a balloon, bladder or other inflatable membrane in communication with an air accumulator connected to a source of pressurized air. The pressurized air supplied to the accumulator expands the balloon or bladder to apply the lens blank against the matching surface of the mold surface with a pressure of about 84 kPa (or about 12.2 psi) thereby spreading the curable coating liquid uniformly over the unpolished fined lens blank surface. Thereafter the coating liquid is cured in situ and the pressure is released and the coated lens blank is removed from the mold. The resulting coated lens has very good light transmission and low haze and eliminates visible fining lines when examined with an arc lamp.

Given the topology of the structured surface of a Fresnel lens the press coating process for an unpolished fined lens blank surface is not directly applicable. In fact attempts at applying press coating process to the coating of the structured side of surface of a Fresnel lens revealed two kinds of defects, so-called cosmetic defects and optical defects.

These defects are caused by shrinking of the coating composition applied to the Fresnel lens blank during curing of the coating composition: the greater the Fresnel structure height the greater resulting shrinkage of the coating composition.

It is advantageous to have thin coating on Fresnel lenses in order to reduce the overall thickness of the resulting lens. But coatings not thick enough to cover satisfactorily the structured surface of the Fresnel lens blank produced surfaces which were not acceptably smooth to provide good optical quality.

While good surface quality can be obtained with coatings of the order of 1 to 2 mm such coating thicknesses are detrimental to the desired reduced overall thickness of the lens.

Another problem encountered was the formation of so-called cosmetic ring void defects, such as schematically illustrated in FIG. 1 which occurs in the peripheral region of the coated structured side of the Fresnel lens blank and consists of rings or non-circular irregular contour lines of variable radial distances from the centre of the lens blank such that the rings or contours lines intersect one another at one or more locations.

### OBJECT AND SUMMARY OF THE INVENTION

It has been discovered that it is possible to obtain a good optical surface quality with an acceptably smooth coated structured surface, that is reduced surface roughness, without excessively thick coatings of the order to 1 or 2 mm, by adapting the coating to the height of the structured surface or Fresnel surface of the Fresnel lens. Specifically by adopting coating thicknesses which are greater than about 1.5 times the height of structured surface, or the Fresnel structure height, but less than about 5.0 times the height of the structured surface, or Fresnel structure height, of the lens. In practice the resulting surface roughness can be made equal to or even less than 300 nm. This results in coating thicknesses in the range of about 100 to about 600 μm.

It has also been discovered that the cosmetic ring void defects resulted from the incident radiation striking the structured surface of the Fresnel which caused irregular shrinkage of the coating resin even when the thickness of the coating exceeded 2.0 times the Fresnel structure height and the cosmetic ring void defects could be totally eliminated by directing incident radiation, here UV radiation, at the Fresnel lens and not at the glass mold contrary to conventional curing procedure. In fact it has been found that the coatings in the range of thickness between about 100 and about 600 μm are particularly sensitive to shrinkage. It is believed that by directing the incident UV radiation to the Fresnel lens the shrinkage develops in the direction opposite to that of the incident radiation. Thus with shrinkage developing from the smooth glass mold surface to the Fresnel structure surface, shrinkage is uniform and produced an acceptably smooth surface. As a result, no irregular shrinkage rings or ring void defects are visible. By contrast when the incident UV radiation is directed at the glass mold, the shrinkage of the coating liquid develops from Fresnel structure surface, again in a direction opposite to that of the incident radiation and results in visible irregular shrinkage rings or ring void defects caused by the development of shrinkage from the irregular Fresnel surface of the lens.

According to the invention there is provided a method for coating Fresnel lenses comprising providing an uncoated Fresnel lens blank having a structured surface and a non-structured surface, providing a transparent mold part having molding surface substantially matching the base curvature of the Fresnel lens, depositing a metered quantity of coating resin between the molding surface and the structured surface of the Fresnel lens, applying pressure between the Fresnel lens and the mold part while maintaining the distance between the molding surface and the structure surface so that the thickness of the coating is between about 1.5 and about 5 times the height of the structured surface, of the Fresnel surface height and about 5 times of height of the structured surface, or Fresnel surface height, and curing the resin coating in situ by directing the incident UV radiation at the Fresnel lens side, not at the glass mold side.

According to the invention one or more the following features may also be adopted.

The pressure applied between the mold and the Fresnel lens blank may be between about 2 and 5 psi (or about 13.8 and about 34.5 kPa).

The thickness of the coating may be between about 1.5 times the Fresnel structure height and about 3 times the Fresnel structure height.

The coating thickness may be between about 75 and 750 μm.

The Fresnel structure height of the Fresnel lens blank may be between about 20 μm and about 300 μm.

A plurality of circumferentially spacers may be disposed between the mold and the Fresnel lens having an axial length between about 80 and about 800 μm and particularly between about 100 and about 600 μm.

According to a further feature, the difference in the refractive index of the Fresnel lens bulk material and the cured coating material is greater than 0.06 and preferably greater than 0.09.

According to a further feature, the refractive index of the cured coating material is between about 1.45 and about 1.55 and the refractive index of the bulk material of the Fresnel lens blank is between about 1.59 and about 1.74.

According to a further feature, coating formulations (or coating materials) are UV curable compounds selected from the group consisting of UV curable (meth)acrylic compounds, epoxy acrylic compounds, epoxy compounds, polyurethane acrylic compounds and any mixture of the aforesaid compounds. According to an embodiment of the present invention the Fresnel lens bulk material is thermoplastic or thermosetting transparent polymer, and preferably a thermoplastic polycarbonate or a thermosetting polymer formed by curing compounds comprising thiourethane group(s) and/or episulfur group(s).

### BRIEF DESCRIPTION OF THE DRAWINGS

Features and advantages of the present invention will be brought out in the following description, given by way of non-limiting examples, with reference to the accompanying drawings in which:

FIG. 1 is a schematic view of the coated structured surface of Fresnel lens blank to illustrate a cosmetic ring void defect, obtained by press coating conducted outside the conditions of the present invention;

FIG. 2 is a schematic view of a coated structured surface of Fresnel lens blank coating obtained by press coating according to the present invention;

FIG. 3 is an axial sectional schematic view of an arrangement for coating a Fresnel lens blank, in an open position after depositing a requisite amount of coating resin;

FIG. 4A is a schematic axial section of an arrangement for coating the structured surface of a Fresnel lens, after closing the molding assembly;

FIG. 4B is a schematic axial view of an arrangement for press coating the structured surface of a Fresnel lens;

FIG. 5 is a schematic top view of the mold part showing the arrangement of a plurality of spacers at the periphery of the mold part;

FIG. 6 is graph of surface roughness (Rq) of a central portion of a coated Fresnel lens blank having a Fresnel structure height of 120 μm and a coating thickness of about 100 μm;

FIG. 7 is a graph of the surface roughness (Rq) in a 40 mm peripheral range or area of a coated Fresnel lens blank having a Fresnel structure height of 120 μm and a coating thickness of about 100 μm;

FIG. 8 is a graph of the surface roughness (Rq) of a 40 mm s peripheral area or area of a coated Fresnel lens blank having a Fresnel structure height of about 80 μm and a coating thickness of about 90 μm;

FIG. 9 is a graph of the surface roughness (Rq) of central portion of a coated Fresnel lens having a Fresnel structure height of about 120 μm and a coating thickness of about 360 μm, according to the present invention;

FIG. 10 is a graph of the surface roughness (Rq) in a 40 mm peripheral range or area of a coated Fresnel lens blank having a Fresnel structure height of about 80 μm and a coating thickness of about 240 μm, according to the present invention.

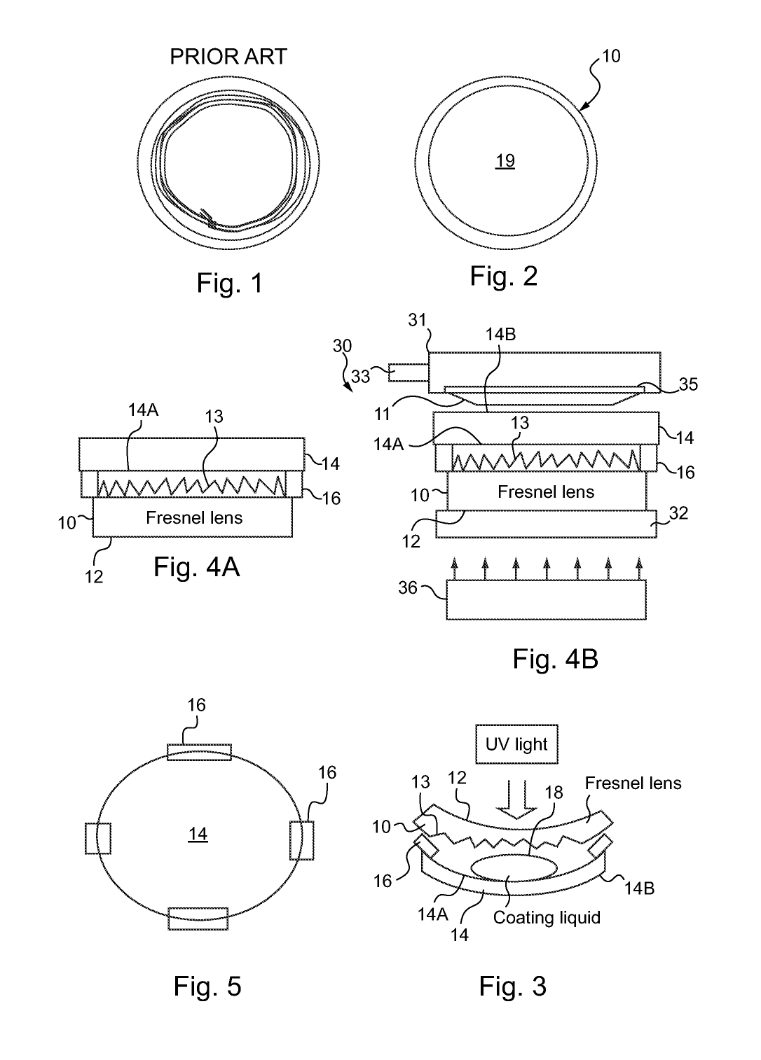

### DETAILED DESCRIPTION OF EMBODIMENTS OF THE INVENTION

The present Fresnel lens blank coating process is intended for Fresnel lens blanks in general and Fresnel lens blanks for ophthalmic purposes such an eyeglass lenses.

The lens blank bulk material may be any high refractive index (nd) mineral glass or plastic material such as those widely used for the ophthalmic lenses and in particular polythiourethanes with a refractive index ranging from 1.60 to 1.67 or polymers formed from episulfide monomers with a refractive index of 1.74, available from Mitsui Chemistry Co or polycarbonates having a refractive index (n_{D}) of about 1.59.

The Fresnel lens blank 10 has a structured surface or side 11 having a plurality of concentric Fresnel ridges of suitable design to provide the desired optical properties such an optical power, Fresnel power or diffractive power, for examples of suitable Fresnel lens designs.

The Fresnel structure or relief profile has a height or so-called Fresnel structure height which is measured between the base curve of the structured surface of the lens and the maximum peak of plurality of ridges defining the Fresnel surface. For ophthalmic applications the Fresnel structure height is preferably between about 20 μm and about 300 μm. The Fresnel power of uncoated structured lens is preferably between +/−6 and +/−12 dioptres.

The coating formulations for use in the invention are suitable for curing by UV irradiation. The cured coating material preferably has a refractive index n_{D} between about 1.45 and about 1.55. The coating material formulation is chosen so that the difference in the index of refraction between the Fresnel lens blank bulk material and the coating material is greater than 0.06 and preferably greater than 0.09. Thus for a Fresnel lens bulk material n_{D} of 1.60, the cured coating material n_{D} will be less than 1.55 and more preferably less than 1.52, for example about 1.50. Coating materials having such a low index also include (meth)acrylic monomers, epoxy acrylic monomers, polyurethane acrylic monomers, fluoro-acrylic monomers, epoxy monomers and polyurethane monomers and their mixtures.

Two coating formulations suitable for application in the present invention are formulations designated 311-83-L and 176-11, whose compositions are as follows:

| | % by mass |
|---|---|
| Components of formulation 311-83-L | |
| Alkoxylated cyclohexane dimethanol diacrylate | 49% |
| Ddiethyleneglycol diacrylate | 39% |
| 1,4-functional dentritic polyester acrylate blend | 10% |
| MBOL | 2% |
| Genocure LTM/photoinitiator | 3% |
| Components of formulation 176-11 | |
| Dipentaerythritol hexaacrylate | 8.7% |
| Dipropylene Glycol Diacrylate | 43.5% |
| Alkoxylated Diacrylate | 17.4% |
| 1,4 Butanediol Diacrylate | 26.1% |
| MBOL | 1.7% |
| Genomer LTM/photoinitiator | 2.6% |

where MBOL = 3-methyl-2-buten-1-ol,

Other formulations are of course possible. Such formulations will satisfy the following criteria, high transparency, low yellowness, low shrinkage, low refractive index between about 1.45 and about 1.55, viscosity, and curable by UV irradiation in a period less than 10 min, good mechanical properties such as impact resistance, permanent adherence to the structured surface of a Fresnel lens blank, and undelaminatable in normal use. The coated Fresnel lens can furthermore be a conventional Rx surfaced or digital surfaced to get the desired lens power in association with the non-structured surface of the lens. Such other possible formulations include monomers containing fluoro acrylic compounds.

Application and curing of the coating composition is preferably carried out by the so-called press coating process mentioned above.

FIG. 4B illustrates apparatus suitable for carrying out press coating process on the structured surface 13 of a Fresnel lens blank 10. The lens blanck also has a non-structured surface 12. The Fresnel lens blank 10 is supported on a lens blank support 32. The lens blank support 32 is fixed and the lens blank is removably mounted on the support by any suitable fastening means (not shown).

A substantially rigid mold part 14 has a molding surface 14A corresponding to the desired external or exposed surface of the coating and an outer surface 14B facing a press coating apparatus. The mold part 14 is made of mold glass composition suitable for molding ophthalmic lenses as is well known in the art. The press coating apparatus 30 for performing press coating comprises a fluid accumulator 31 such as an air accumulator provided with a fluid port, here an air port 33, adapted to be connected to a source of pressurized air or other suitable fluid (not shown) for introducing pressurized fluid into the accumulator and for evacuating the pressurized air from the accumulator. The accumulator may have a flexible membrane or bladder 35 adapted to bear against the side of the mold part surface 14B remote from the molding surface. Finally a UV lamp 36 is disposed to the side of the Fresnel lens remote from the mold part so that incident UV radiation is directed at the Fresnel lens, that is, the non-structured surface or side 12 thereof.

The Fresnel lens blank 10 is mounted on the lens blank support 32 and if desired secured thereto. A plurality of spacers 16, four as illustrated, are positioned at the periphery of the Fresnel lens blank 10 and extend in the same direction as the relief pattern or the structured surface 13 of the lens blank. A metered amount of the curable coating composition is deposited on the structure surface 13 of the Fresnel lens and the mold part 14 is positioned on the spacers (see FIG. 3). Pressurised air is then supplied to the fluid accumulator to inflate the inflatable balloon or bladder 35 which applies the desired light pressure to the mold and thereby ensures in association with the spacers 16 that the resulting coating is of the desired thickness. After molding the coating composition is cured in situ. The UV source 36 is turned on long enough to ensure curing the coating composition. After curing the pressurized air can be exhausted from the accumulator through the air port 33 so that the mold part 14 and spacers 16 can be removed and the Fresnel lens withdrawn from the press coating apparatus.

Examples of the press coating process according to the invention and comparative examples will now be given.

### Example 1

A 4.0 base Fresnel lens blank of polycarbonate having a refractive index of 1.59 was injection molded. In the present example the Fresnel structure or the structured surface of the Fresnel lens blank was located on the convex side of a convex-concave lens blank. The Fresnel structure height of the structured surface of the Fresnel lens blank was 150 μm and the optical power of the Fresnel lens design in air was +6.0.

A corresponding 4.0 base glass mold part had a molding surface which matches the curvature of the Fresnel lens structured surface. So-called spacer tape was used for defining the plurality of spacers between the mold part and the Fresnel lens blank. The spacer tape portions were applied to the edge of the glass mold part at circumferentially spaced locations and also to the edge of the Fresnel lens blank and served to calibrate the thickness of the coating composition in association with the application of light pressure by the air balloon or bladder. The spacer tape portions have an axial length of 0.30 mm, slightly greater than the desired thickness of the coating composition.

The coating composition was a UV curable low index coating solution was formulation 311-83-L specified above and as shown in the above table has a refractive index of 1.50 after curing. A metered quantity of a total of 0.9 g of drops of the curable coating solution was deposited onto the molding surface of the glass mold part and then the Fresnel lens blank was carefully brought into contact with the drops of coating solution such that the coating solution spread over the entire lens-mold surface.

A light air balloon or bladder pressure of about 2 to 3 psi (or about 13.8 to 20.7 kPa) was applied to the non-structured surface of the Fresnel lens for better control of the thickness of the coating.

UV radiation from a Dymax UV lamp was then directed for 1 to 2 min. at the non-structured surface of the Fresnel lens side to cure the coating composition in situ. After UV curing of the coating composition, the glass mold part and spacers were removed to access and withdraw the coated Fresnel lens.

The coating thickness was about 250 μm, reckoned from the ‘free face’ of the structured surface of the Fresnel lens. The coated lens provided a very good optical image and the surface roughness (Rq) of the coated Fresnel lens surface was less than 200 nm. The coating composition filled the spaces between the ridges of the structured surface and contained no trapped air bubbles or voids when checked by naked eye and microscopy. Nor were there any ring void defects or other visible defects. The coated Fresnel lens had a Fresnel power of +1.0. The resulting coated Fresnel lens blank was fully compatible with conventional Rx surfacing or digital surfacing and edging, and hardcoating desiderata for obtaining the desired eyeglass lens prescription.

### Example 2

The modalitites of this example were the same as those of Example 1, except as regards the axial length of the spacer tape portions which were approximately 650 μm to obtain a coating thickness of about 620 μm. The surface quality of the much thicker coating of Example 2 is even better than that of Example 1. The surface roughness was less than 100 nm and the optical quality was good, too.

### Example 3

The modalities of this example were the same as those of Example 1, except that the Fresnel lens bulk material is a high index polythiourethane (n_{D}=1.60). The polythiourethrane lens is of the same design as the polycarbonate Fresnel lens of Examples 1 and 2. The resulting coated Fresnel lens blank lens produced the press coating process had the same good optical and cosmetic qualities as coated lens blank of Example 1.

### Example 4

The modalities of this example were the same as those of Example 1, except the polycarbonate Fresnel lens blank has a lower Fresnel structure height of 80 μm and the axial length of the spacer tape was 0.15 mm. The coating thickness obtained by the press coating process is about 240 μm. The coated Fresnel lens blank had very good optical and cosmetic qualities. The Fresnel power was again +1.0.

### Comparative Examples 1-6

These examples were same as Example 1 or Example 3, except as regards coating thicknesses and direction of the incident UV radiation and UV-curable monomers. The resulting Fresnel lens blanks have either optical visual quality defects or cosmetic defects due to the coating resin shrinkage.

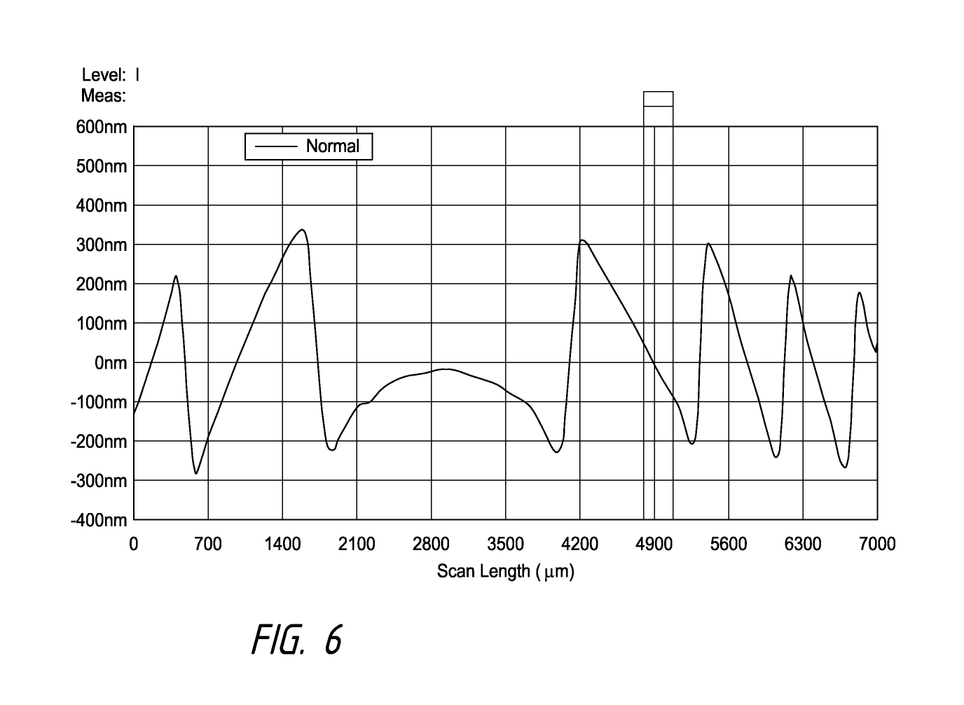

The surface roughness (Rq) of the coating surface of Comparative Example 1 is illustrated in the graph of FIG. 6 and the values are given in the Table above, including a value of surface roughness (Rq) greater than 500 nm which is well in excess of acceptable values of surface roughness for an ophthalmic lens and is likely to negatively affect optical visual quality thereof.

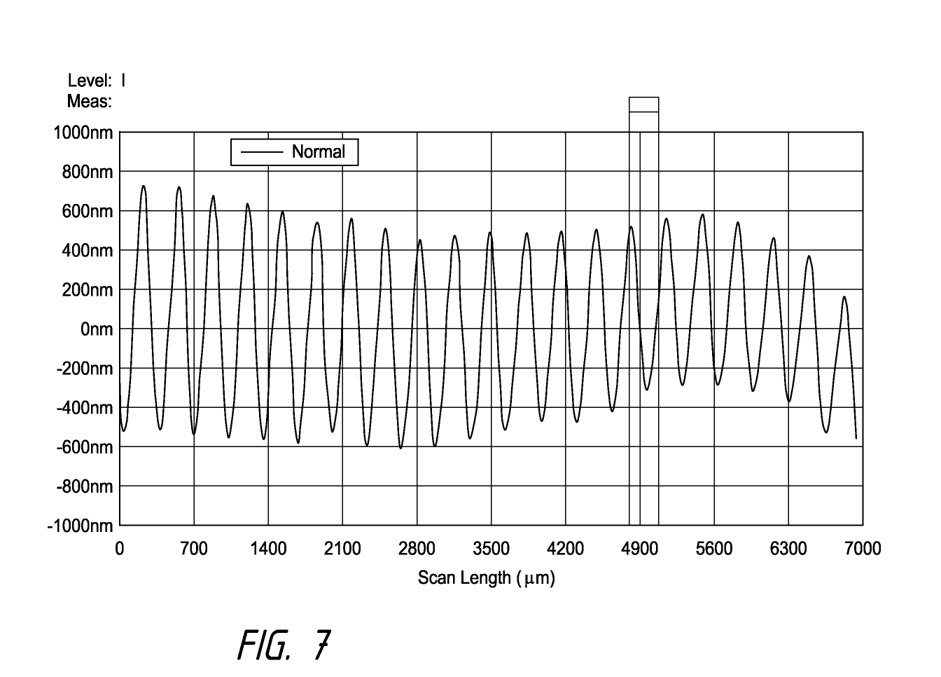

The surface roughness (Rq) of the coating surface of Comparative Example 1, for limited 40 mm range of the lens blank, is illustrated in the graph of FIG. 7 with values of Rq consistently greater than 500 nm, well in excess of acceptable values of surface roughness for an ophthalmic lens and is likely to negatively affect optical visual quality thereof.

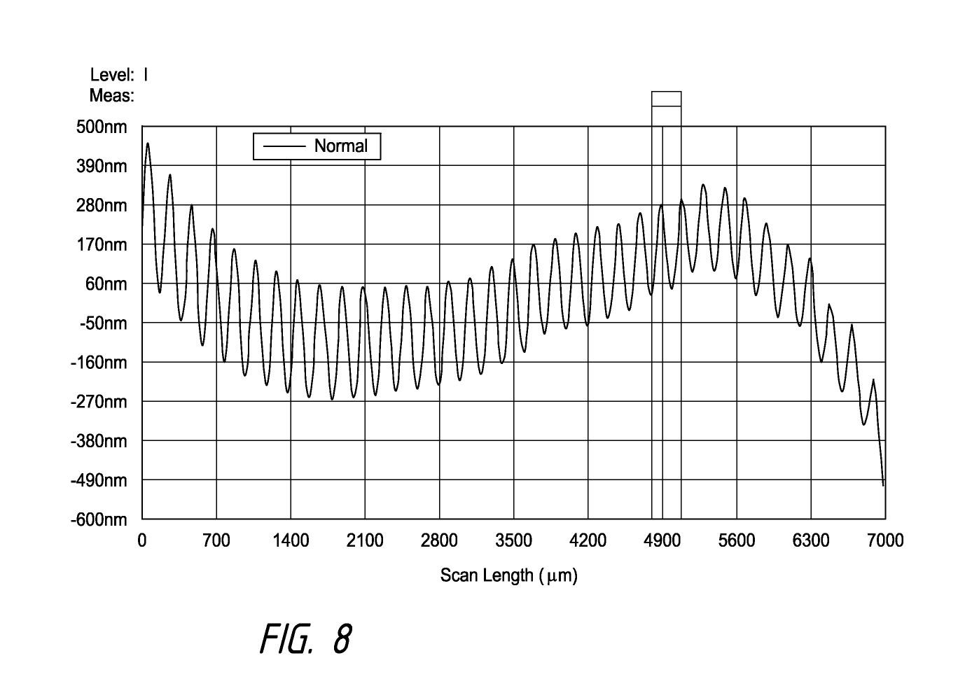

The surface roughness (Rq) of the coating surface of Comparative Example 2 for a Fresnel lens having a Fresnel structure height of 80 μm and a coating thickness above the structured surface of 90 μm is illustrated in the graph of FIG. 8, with values of Rq greater than 300 nm and with very small pitch from peak to vale, well in excess of acceptable values of surface roughness for an ophthalmic lens and is likely to negatively affecting optical visual quality thereof.

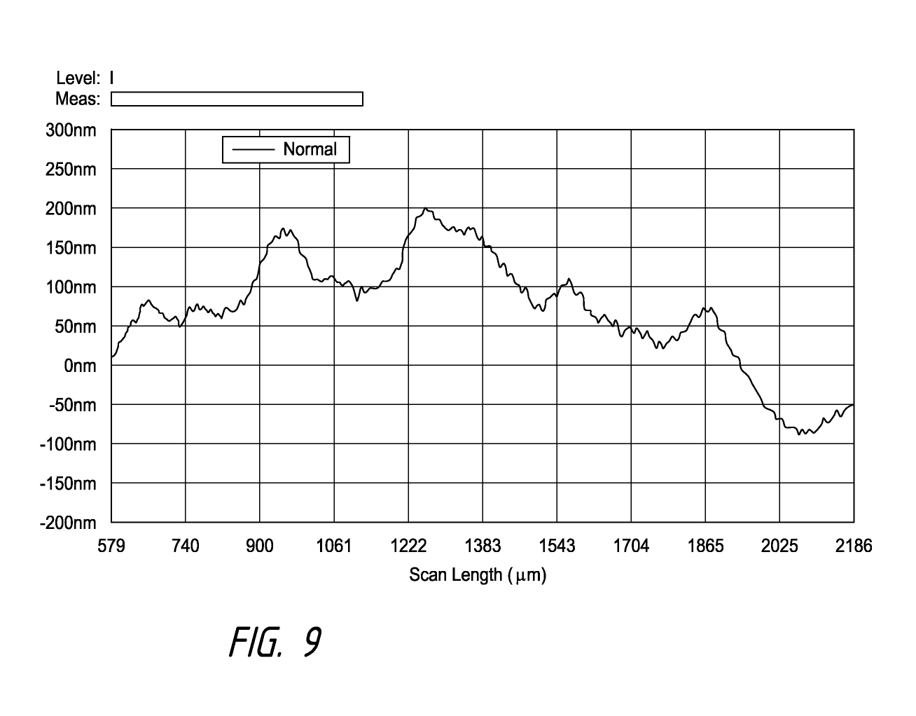

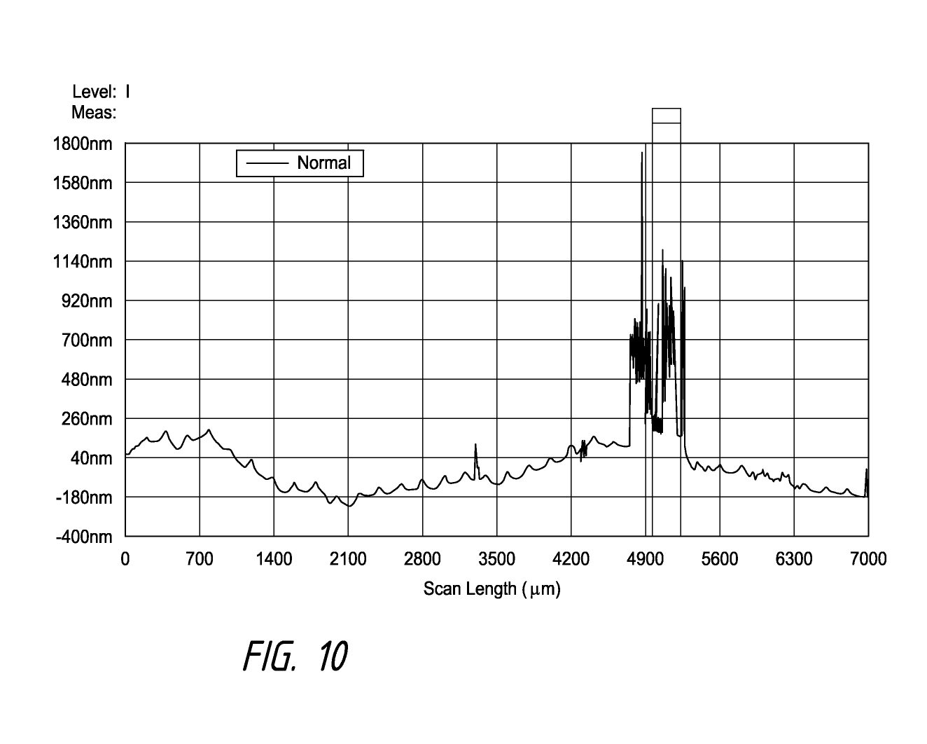

The surface roughness (Rq) of the coating surface of Example 1 according to the invention for a Fresnel lens having a Fresnel structure height of 120 μm and a coating thickness above the structured surface of 360 μm is illustrated in the graph of FIG. 9, with values of Rq less than 100 nm which is fully satisfactory for an ophthalmic lens to ensure good optical visual quality.

The surface roughness (Rq) of the coating surface for a limited peripheral range of 40 mm of Fresnel lens blank of Example 4 having a Fresnel structure height of 80 μm and a coating thickness above the structured surface of 240 μm less than 200 nm which is fully satisfactory for an opthalmic lens to ensure good optical visual quality of the Fresnel lens.

The conditions and results of Examples 1-4 and Comparative Examples 1-6 are enumerated in the following table:

| | | Fresnel | | | | | | | | Coated | Coated | | |
|---|---|---|---|---|---|---|---|---|---|---|---|---|---|
| | | struc- | Coat- | Coat- | Spacer | Air | | | Coating | Surface | Surface | Optical | Coating |
| Exam- | | ture | ing | ing | thick- | balloon | | | thick- | roughness | roughness | visual | cosmetic |
| ple | Lens | height | liquid | mass | ness | pressure | UV direction | UV lamp | ness | (Height) | (Width) | quality | quality |
| Ex. 1 | PC | 120 μm | 1.5 | 0.9 g | 300 μm | 3 psi | Incident UV | Dymax | 360 μm | <200 nm | >150 μm | Good | Good |
| | | | | | | | At Fresnel lens | | | | | | |
| Ex. 2 | PC | 120 μm | 1.5 | 0.9 g | 600 μm | 4 psi | Incident UV | Dymax | 620 μm | <100 nm | >1000 μm | Good | Good |
| | | | | | | | At eFresnel | | | | | | |
| | | | | | | | lens | | | | | | |
| Ex. 3 | PU | 120 μm | 1.5 | 0.9 g | 300 μm | 3 psi | Incident UV | Dymax | 350 μm | — | — | Good | Good |
| | | | | | | | At Fresnel lens | | | | | | |
| Ex. 4 | PC | 80 μm | 1.5 | 0.45 g | 150 μm | 3 psi | Incident UV | Dymax | 240 μm | <200 nm | >150 μm | Good | Good |
| | | | | | | | At Fresnel lens | | | | | | |
| Com. | PC | 120 μm | 1.5 | 0.45 g | 150 μm | 3 psi | Incident UV | Dymax | 100 μm | >500 nm | <50 μm | Not good/ | Good |
| Ex. 1 | | | | | | | At Fresnel lens | | | | | Double | |
| | | | | | | | | | | | | image | |
| Com. | PC | 80 μm | 1.5 | 0.3 g | 0 | 3 psi | Incident UV | Dymax | 90 μm | >300 nm | <50 μm | Not good/ | Good |
| Ex. 2 | | | | | | | At Fresnel lens | | | | | Double | |
| | | | | | | | | | | | | image | |
| Com. | PC | 120 μm | 1.5 | 0.9 g | 300 μm | 3 psi | Incident UV at | Dymax | 250 μm | — | — | Good | Several |
| Ex. 3 | | | | | | | Mold | | | | | | ring void |
| | | | | | | | | | | | | | on |
| | | | | | | | | | | | | | coating |
| Com. | PC | 120 μm | 1.5 | 0.9 g | 300 μm | 3 psi | Incident UV at | Zenon | 250 μm | — | — | Good | Several |
| Ex. 4 | | | | | | | Mold | | | | | | ring void |
| | | | | | | | | | | | | | on edge |
| | | | | | | | | | | | | | coating |
| Com. | PC | 120 μm | 1.51 | 0.9 g | 300 μm | 0 | Incident UV at | Dymax | 250 μm | — | — | Good | Several |
| Ex. 5 | | | | | | | dMold | | | | | | ring void |
| | | | | | | | | | | | | | on edge |
| | | | | | | | | | | | | | coating |
| Com. | PC | 120 μm | 1.5 | 0.9 g | 300 μm | 3 psi | Incident UV at | Dymax | 250 μm | — | — | Good | Several |
| Ex. 6 | | | | | | | Mold | | | | | | ring void |
| | | | | | | | | | | | | | on edge |
| | | | | | | | | | | | | | coating |

The present invention is not intended to be limited to the embodiements described herein but on the contrary is intended to extend to Fresnel lens coating processes and the resulting coated Fresnel lens within the scope of the appended claims.

What is claimed is:

1. A method for coating a Fresnel lens comprising providing an uncoated Fresnel lens blank having a structure surface and a non-structured surface, providing a transparent mold part having molding surface substantially matching the base curvature of the Fresnel lens, depositing a metered quantity of coating resin between the molding surface and the structured surface of the Fresnel lens, applying pressure between the Fresnel lens and the mold part while maintaining the distance between the molding surface and the structure surface so that the thickness of the coating is greater than 1.5 times the Fresnel structural height of the structured surface and less than 5 times of the Fresnel structure height of the structured surface and curing the resin coating in situ by directing the incident UV radiation at the Fresnel lens.

2. A method for coating a Fresnel lens according to claim 1, wherein the pressure applied between the mold and the Fresnel lens blank is between about 2 and 5 psi (or about 13.8 to 34.5 kPa).

3. A method for coating a Fresnel lens according to claim 1, wherein the thickness of the coating is between about 1.5 times the Fresnel structure height and about 3 times the Fresnel structure height.

4. A method for coating a Fresnel lens according to claim 1, wherein the coating thickness is between about 75 and about 750 μm.

5. A method for coating a Fresnel lens according to claim 1, wherein the Fresnel structure height of the Fresnel lens blank is between about 20 μm and about 300 μm.

6. A method for coating a Fresnel lens according to claim 1, wherein a plurality of circumferentially spacers are disposed between the mold and the Fresnel lens having an axial thickness between about 100 to about 800 μm.

7. A method for coating a Fresnel lens according to claim 1, wherein a plurality of circumferentially spacers are disposed between the mold and the Fresnel lens and have an axial length between about 150 μm and about 600 μm.

8. A method for coating a Fresnel lens according to claim 1, wherein the difference in the refractive index of the Fresnel lens bulk material and the cured coating material is greater than about 0.05.

9. A method for coating a Fresnel lens according to claim 1, wherein the difference in the refractive index of the Fresnel lens bulk material and the cured coating material is greater than about 0.08.

10. A method for coating a Fresnel lens according to claim 1, wherein the refractive index of the cured coating material is between 1.45 and 1.55 and the refractive index of the bulk material of the Fresnel lens blank is between 1.59 and 1.74

11. A method for coating a Fresnel lens according to claim 1, wherein the coating formulations are UV curable compounds selected from the group consisting of UV curable (meth) acrylic compounds, epoxy acrylic compounds, epoxy compounds, polyurethane acrylic compounds and any mixture of the aforesaid compounds.

12. A method for coating a Fresnel lens according to claim 1, wherein the Fresnel lens bulk material is a thermoplastic polycarbonate or a thermosetting polymer formed by curing compounds comprising thiourethane group(s) and/or episulfur group(s).
